(19) United States
(12) Patent Application Publication
(10) Pub. No.: US 2006/0185235 A1
(43) Pub. Date: Aug. 24, 2006

(54) Seed germination, growth and gardening kit

(76) Inventor: Eric S. Bono, Pittsburgh, PA (US)

Correspondence Address: MOAZZAM & ASSOCIATES, LLC, 7787 LEESBURG PIKE, SUITE 200, FALLS CHURCH, VA, 22043, US

(21) Appl. No.: 11/345,700

(22) Filed: Feb. 2, 2006

Related U.S. Application Data
(60) Provisional application No. 60/653,613, filed on Feb. 16, 2005.

(51) Int. Cl. A01C 1/04

(52) U.S. Cl. 47/56

(57) ABSTRACT

A kit for germinating and growing plant, herb, flower and vegetable seeds in a simplified manner. The seeds can be placed on a mat comprised of growth material and can germinate and grow in the mat, reaching full maturity. The kit requires no surface preparation and can be placed on any surface or in any container outdoors or indoors. In addition, the kit provides a method for simplified gardening. The kit can be packaged in many different ways and with additional instruments to provide a wide-range of simplified gardening options. The kit can also be used as an educational tool to teach gardening and easily display a plant's root system.

### CLAIM FOR BENEFIT OF PRIORITY

This application claims the benefit of priority of U.S. Provisional Patent Application No. 60/653,613, filed on Feb. 16, 2005, and having a common inventor. U.S. Provisional Patent Application No. 60/653,613 is incorporated by reference in its entirety herein.

### STATEMENT OF FEDERALLY SPONSORED RESEARCH

Not applicable.

### BACKGROUND OF THE INVENTION

1. Field of the Invention

This invention relates to a novel seed germination, growth, and gardening kit, as well as a method for increasing ease in seed germination, growth, and gardening.

2. Description of the Background Art

Many people appreciate the benefits a garden can offer to their home or business. Flower gardens provide an attractive accent to any building and add aesthetic value. Vegetable and herb gardens are also a desired accoutrement and provide fresh produce and herbs as well as adding beauty and wonderful aromas to an environment. As people's schedules become more and more hectic the time necessary to devote to cultivating a garden diminishes, and most try to find an easier way to obtain the benefits of a garden without all the work. In addition, as people live more closely together space decreases and people have less room to garden.

To plant a garden many tools and a large time commitment have typically been required. The ground must be prepared or tilled to receive the seeds. If the soil is not of good quality, topsoil must be laid and prepared for the seeds. The seeds then need to be spaced dependent on what type of plant the seeds will produce. Fertilizer must be added and the seeds need to be covered with soil. Mulch is then added over the planted seeds to prevent erosion and preserve moisture. The ground must then be kept very moist for the seeds to germinate. During an especially hot season the ground can easily dry and must be watered several times a day.

Once the seeds germinate and sprouts appear they often need to be thinned to allow maximum growth. In addition, frequent weeding is necessary or the unwanted weeds can choke out the flower and/or vegetable plants. Weeding can take large amounts of time and requires bending and kneeling, which can be difficult to do for an extended period. Furthermore, some plants can be difficult to grow and require even more maintenance and upkeep than is typically required.

Various gardening and germination aids are available, but many require underlying soil that must be prepared and most need to be covered with and/or surrounded by topsoil for germination and growth to occur. In addition, such aids are lightweight and can easily be blown away. The sheets dissolve eventually after watering and supply no actual anchoring or strength to the plants. They are therefore not suitable for continued growth of plants past germination. In addition, they can reportedly only be used in the soil outdoors. While the present invention can be used inside or outside, on any surface or in any container.

Hydroponic growing systems may involve use of similar growth mats. However, they do not have the kit components or ease offered by the present invention. In addition, the present invention is a kit that allows the gardener to grow a complete garden without any other necessary elements, which is not the case in hydroponic gardening.

Because so many people would like a beautiful garden that is also easy to prepare, grow and maintain, it is an object of the invention to provide a kit and method of gardening that supplies an easy solution to the many difficulties involved in preparing and maintaining a garden, and in assembling the necessary components. The inventive kit's contents can be optimized and/or selected to be used both indoors and outdoors, and can be placed on any type of surface or in a container. Of course, the breadth and scope of the invention as defined by the claims should not be limited by reference to any object of the invention.

### SUMMARY OF THE INVENTION

In one aspect the invention is a kit that includes a gardening mat, seeds and fertilizer. The seeds and fertilizer can be contained in separate containers or contained in the mat. In a further aspect instructions on how to grow the seeds may be included with the kit, or in yet a further aspect the instructions could be integrally printed on the mat or on a container included in the kit. In another aspect the mat is bound with a biodegradable polymer. In still a further aspect of the invention the mat could include, but is not limited to, peat moss, coconut coir, combusted bark, fresh bark, composted organic waste, expended volcanic ash, milled corncob, nut shells, seed hulls, sawdust, hemp, silk, cellulose, wool or a mixture of two or more of the above-identified components. In another aspect of the invention the kit includes a cardboard backing to aid in the packaging of the kit and provide stability to the kit. In a further aspect the kit, with or without a backing or other components, can be shrink-wrapped together for ease in packaging, transporting and selling the kit. In another aspect the mat can be rolled and/or folded for storage and packing and included in the kit.

In yet another aspect of the invention the mat contains at least one preformed receptacle to receive the seed or seeds and fertilizer. In a further aspect the fertilizer and/or the seeds can be already placed in the receptacles or otherwise imbedded in the mat to provide further ease in germinating and growing seeds. In another aspect of the invention there can be at least three receptacles that can be arranged in any pattern to provide for the growth of flowers or plants in a pre-arranged design that may be functional and/or decorative. In yet a further aspect of the invention the mat can be pre-cut in a decorative shape or the mat could be cut into various sizes by a purchaser. Additionally, the mat may be provided with perforations either in a decorative shape or simply dividing the mat into sections, to assist a user in cutting the mat into a desired shape or size. In another aspect the kit could include at least two mats. The mats may be different sizes. In still a further aspect the kit could include additional mats and additional seeds. In another aspect the seed or seeds included in the kit can be coated with clay to make the seeds easier to handle and plant.

In another aspect of the invention the kit can contain gardening implements, such as gardening gloves or a gardening shovel, for use in gardening. In yet another aspect of the invention the kit could include a container for the mat, and in a further aspect the mat could be sized to easily mount inside the container. In another aspect of the invention the mat can range in thickness from about 0.25 inches thick to about 3.0 inches thick. However, it should be noted that the mat may be of any thickness to suit a particular purpose.

In another aspect the invention provides a method of cultivating a garden, indoors or outdoors. In a still further aspect of the invention the kit can include a growth stand and growth lights to optimize indoor germination and growth of the seeds. In still another aspect of the invention the kit can include a perforated tray and an exterior container able to be fitted thereto, and the tray may be removed from the container during growth to expose the root growth for educational demonstration.

### BRIEF DESCRIPTION OF THE FIGURES

FIG. 1 shows one aspect of the invention, an assembled kit including a mat, seeds, instructions, and fertilizer.

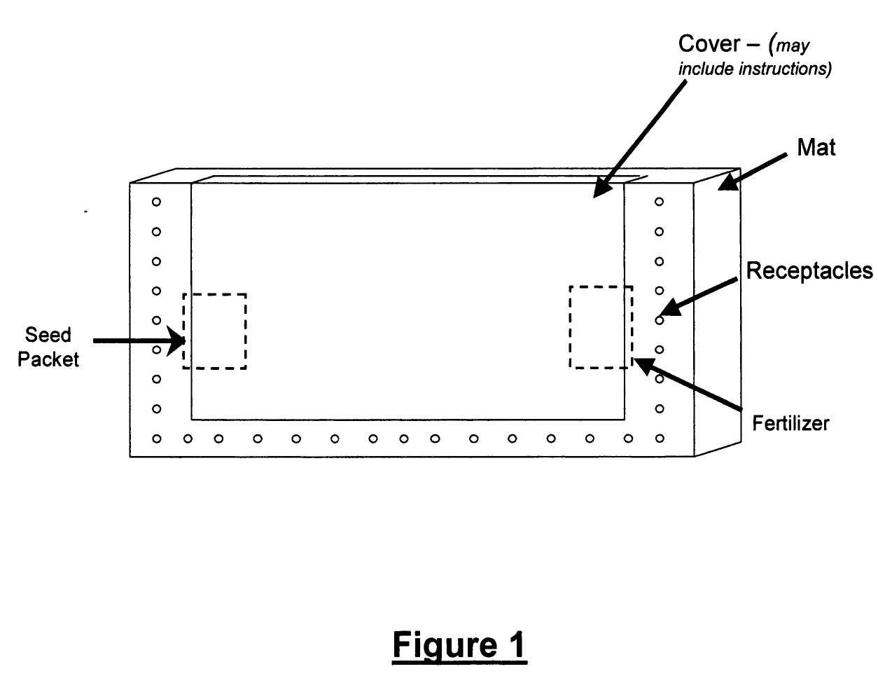

FIG. 2 shows a disassembled kit (exploded view) of the invention including a mat, seeds, instructions, and fertilizer.

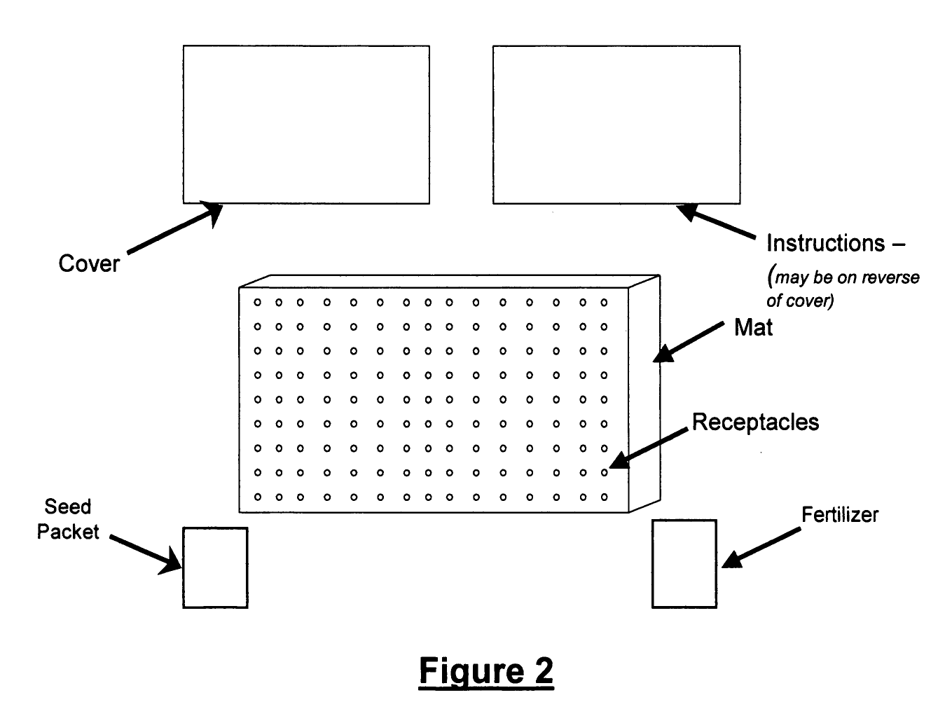

FIG. 3 shows a mat that may be used in the invention, including perforations and depressions/receptacles into which fertilizer and/or seeds may be placed.

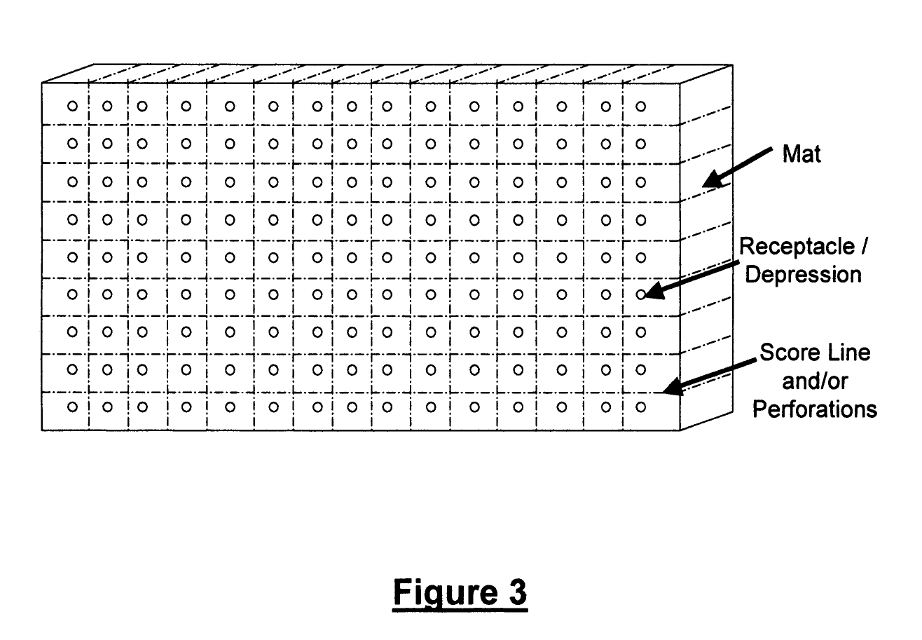

FIG. 4 shows a disassembled kit (exploded view) of the invention including a growth light, mat, seeds, instructions, and fertilizer.

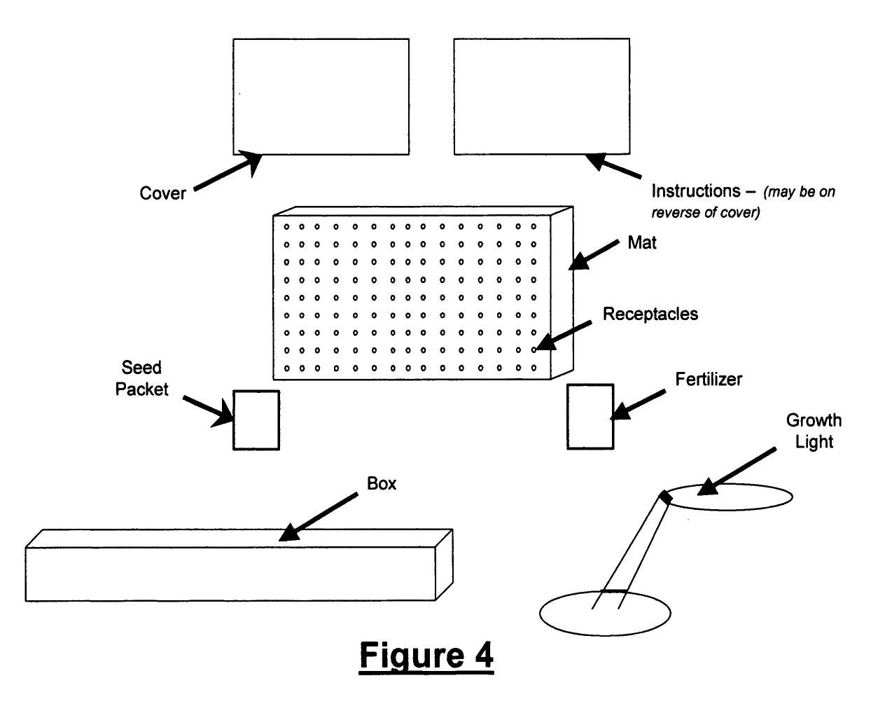

### DETAILED DESCRIPTION OF THE INVENTION

In one aspect the invention is a kit for germinating and growing seeds that includes for example, but is not limited to, a mat, seeds, and fertilizer. Instructions for the use of the kit may also be included or integrally printed directly on the mat. The mat may be made from an organic or a synthesized material combination, and may be bound together with another material or materials. For example, the mat may be bound with hydrophilic polyurethane. The hydrophilic polyurethane may be a hydrophilic polymer. For example, the hydrophilic polymer sold under the tradename HYPOL JT® brand, which is available from Dow Chemical Company, may be used, but the bonding material is not limited to this substance. The organic material can include for example, but is not limited to peat moss, coconut coir, combusted bark, fresh bark, composted organic waste, expended volcanic ash, milled corncob, nut shells, seed hulls, sawdust, hemp, silk, cellulose, wool or a mixture of two or more of these. Those skilled in the art will recognize others. The synthesized material may include but is not limited to polyesters, polyacrylonitrile, polyvinyl alcohol, polyolefims, polyamides and cellulose-based materials. One suitable mat composition is described for example in U.S. Pat. No. 4,619,948 to T. Scott Kennedy, incorporated by reference herein. In addition, the growth medium (organic or synthesized material or a combination thereof) could be bound together by a biodegradable plant-based polymer.

The elements of the inventive kit can be contained in separate containers within the kit. The seed(s) can be held in their own separate container, and the fertilizer, if included, can be held in its own distinct separate container. The separate containers can then be packaged together with the mat. In another aspect the seeds and fertilizer can be packaged directly in or with the mat. The inventive kit can be shrink-wrapped together or contained in a box, package, bag, planting container or any other article suitable for packaging or containment.

Because of the sturdy nature of the growth medium selected for the mat, no additional planting or soil is needed to germinate and grow seeds in the mat. Of course, a kit user is free to add or prepare soil at his/her discretion. Water may be necessary to germinate the seeds. In one aspect of the invention, the mat absorbs water and the addition of water causes the mat to expand, like a sponge. The water may also weigh the mat providing a stable platform for the germination and root growth. The seeds can grow and mature in the mat, and no re-planting or movement of resulting plants is required. Because the plant can develop fully in the mat, usually no soil is necessary, though it may be used if desired. Soil may be necessary when using the mat for growth in a container. Soil may be included in a kit or provided by the user. The mat included in the kit may be used one time or may be re-used for two or more growth cycles to germinate and grow seeds.

The present invention increases ease in gardening by reducing the time necessary to complete certain gardening steps. In addition, the mat may hold moisture more effectively than conventional soil and reduces necessary weeding. Furthermore, it may be used on any type of surface or in any desired container, and can be used to grow many different varieties of plants, vegetables, flowers and herbs, and does not require re-planting to continue the growth of the resulting plants through maturity.

The inventive kit can be packaged in numerous ways and designs. For instance, the kit could be packaged in a cardboard or stiff millboard box. The kit could be shrink-wrapped together and it could include cardboard or other backing to provide stability to the package. In addition, the mat could be rolled in a cylindrical shape, folded, or scored and folded especially for ease in packaging a larger-sized mat.

The kit can be used anywhere regardless of the surface. In addition, no surface preparation is needed, so it is an easy solution to gardening. Any type of seed desired and appropriate to the environment of use can be grown with the kit, and the use of seeds other than those included in the kit is possible. Furthermore, the seeds provided can be clay-coated. The clay-coated seeds can be easier to use and require less manipulation. Fertilizer may be included in the kit and is used to provide the seeds and plants with optimal nutrients and enhance growth. Instructions may be provided to explain, for example, a method of germinating and growing seeds using the inventive kit.

Many different varieties of plants and vegetables can be grown using the inventive kit. Vegetables, herbs, flowers and decorative plants can all be cultivated in the kit. Although several types of possible plants are mentioned here, it is not limited to these only, and any type of plant, vegetable, flower, herb, etc. can be grown using the inventive kit without departing from the spirit and scope of the present invention. Different types or brands of seeds may be included in the kit. Brands of seeds including but not limited to BURPEE® brand seeds, JOHNNY'S SELECTED SEEDS® brand seeds, or STOKES SEEDS® brand seeds may be used. In addition, the inventive kit may include different brands of fertilizers as well, including but not limited to MIRACLE-GRO® brand fertilizer, JACK'S CLASSIC® brand fertilizer, or EARTH JUICE® brand fertilizer. The fertilizer can be used on the mat at anytime, before, during or after planting the seeds, but is optimally used about 3 to 4 days after the seed(s) germinate.

The inventive kit can provide more convenience by including a mat that contains receptacles already placed in the mat. The receptacles are small holes formed in the mat that do not extend fully through the mat. Of course, the mat also contemplates the inclusion of holes that pass entirely through the mat. The seeds and the fertilizer can be placed into the receptacles to allow for germination. The mat can be further enhanced by placing the seeds and/or the fertilizer in the mat at the production level so that no planting or fertilizing is necessary once the kit is obtained. In addition, to provide an ornamental design the receptacles can be arranged in any design to provide for plant or flower growth in a decorative configuration.

The inventive kit can include various gardening tools, such as gloves or gardening implements. In addition, the kit could be packaged with a container, and in this configuration the mat would be sized to easily fit into the container. The container could be any shape, size or type of container. For example, the container could be a window box, or a container that fits over or on a porch or deck railing, or any other type of container suitable for use in germinating and growing seeds with the inventive kit. One skilled in the art can recognize that a more detailed container growth analysis could be achieved to determine the optimal thickness of a mat for a particular type of seed or plant in a container. Seed germination and gardening kits could be specifically formulated for a certain type of seeds or plant in a particular container so that the thickness of the mat and most ideal environment could be included in the instructions for that kit.

The mat included in the inventive kit could be cut to a specific size or shape by the purchaser (with or without the use of perforations), or the kit could include a particular size or shape mat. The mat can range anywhere in size and shape, and the combinations are virtually limitless. The mat may have a thickness of about 1.25 inches to 1.5 inches, about 1 inch to 2 inches, about 0.5 inches to 3 inches, about 0 to 0.5 inches, and greater than 3 inches. A thickness of about 1.25 inches is preferred. Although growth results from thicker mats tend to be better than results from thinner mats, any mat or mats in the stated ranges may be used. The thickness of a mat may be approximately uniform throughout, though that is not required.

In addition, the inventive kit could include several sizes of mats, or several different shapes of mats so that numerous gardening designs could be achieved with the kit. Different types of seeds could be included so that one kit could create a garden with different varieties of vegetables, plants, flowers, herbs, etc.

In a further aspect, the invention provides a simplified method for gardening. The method can be utilized outdoors by providing a mat, providing seeds and providing fertilizer. The mat can be placed on any surface, or in any container, outside where a garden is desired without any preparation of that underlying surface. The mat could be placed over grass, over a prepared bed, or in a container. The mat may also be placed over an unprepared surface, including surfaces not normally used for gardening, such as gravel, concrete, or asphalt. The seeds may then be placed on the mat, or in the receptacles formed in the mat and followed with the fertilizer. After this is done the mat containing the seeds and fertilizer need only be watered and kept moist to germinate the seeds and allow them to grow. Minimal upkeep is then necessary to keep the plants alive. If desired the mat may be fully or partially buried under a layer of soil.

In a further aspect of the invention the method can be accomplished indoors as well. The method can be utilized by providing a mat, providing seeds and providing fertilizer. The mat can be placed on any surface, or in any container, inside where a garden is desired without any preparation of that underlying surface. The seeds must then be placed on the mat or in receptacles formed in the mat and followed with the fertilizer. After this is done the mat containing the seeds and fertilizer need only be watered and kept moist to germinate the seeds and allow them to grow. Either natural sunlight or artificial light from lamps could be used to germinate and grow the seeds.

In addition, a growing stand and growing light can be included in the inventive kit to better facilitate the method of simplified growing indoors. One skilled in the art will recognize that different types of growth lamps could be used to determine the best wattages, distances, durations and temperatures for different types of seeds and that a detailed germination and growth chart could be prepared to describe exactly what would be the ideal indoor growth environments for different types of seeds.

Still further the inventive kit can include a perforated tray and a container sized to hold the tray. The mat can be placed on the tray in the container and the seeds may germinate and grow on the perforated tray. As the root system grows it will grow through the perforations in the tray. The tray can then be lifted from the container to allow for simplified visual or educational demonstrations of the plant's root system during growth.

### EXAMPLES

The following examples describe use of the kit of the present invention and methods of using the kit of the present invention.

### Example 1

After the threat of frost had passed in the region of use the mat was laid outside directly on the lawn without any surface preparation or tilling. The mat was saturated with water. Lettuce seeds were placed in receptacles formed in the mat. The mat was kept moist to allow the seeds to germinate and grow. The seeds sprouted and the small sprouts were visible in about 4 days. When the plants reached about 3 inches about one teaspoon of fertilizer was mixed with one gallon of water and applied to the mat, although the fertilizer can be applied at any time. The remaining fertilizer was applied in the same manner in about an additional 4 weeks, although it can be applied at any time. The lettuce was then harvested when it reached an optimal size. After the growing season when all lettuce had been harvested the mat was saved. It was reused in the same manner the next growing season. This example was also performed using basil, oregano, parsley, sage, rosemary, thyme and bean seeds using the same or different mats.

### Example 2

After the threat of frost had passed in the region of use the mat was laid outside over a prepared soil bed. The mat was saturated with water. Lettuce seeds were placed in receptacles formed in the mat. The mat was kept moist to allow the seeds to germinate and grow. The seeds sprouted and the small sprouts were visible in about 4 days. When the plants reached about 3 inches about one teaspoon of fertilizer was mixed with one gallon of water and applied to the mat, although the fertilizer can be applied at any time. The remaining fertilizer was applied in the same manner in about an additional 4 weeks, although the fertilizer can be applied at any time. The lettuce was then harvested when it reached an optimal size. After the growing season when lettuce had been harvested the mat was saved and reused in the same manner in a subsequent growing season. This example was also performed using basil, oregano, parsley, sage, rosemary, thyme and bean seeds.

### Example 3

The mat was placed inside in a container not containing any soil. The mat was saturated with water. The container was exposed to natural sunlight. Lettuce and basil seeds were placed in receptacles formed in the mat. The mat was kept moist to allow the seeds to germinate and grow. The seeds sprouted and the small sprouts were visible in about 4 days. When the plants reached about 3 inches about one teaspoon of fertilizer was mixed with one gallon of water and applied to the mat, although the fertilizer can be applied at any time. The remaining fertilizer was applied in the same manner in about an additional 4 weeks, although the fertilizer can be applied at any time. The lettuce was then harvested when it reached an optimal size. After the growing season when all lettuce was harvested the mat was saved and reused in a subsequent season.

### Example 4

The mat was placed inside in a container containing soil. The mat was laid on top of the soil. The mat was saturated with water. The container was exposed to natural sunlight. Lettuce and basil seeds were placed in receptacles formed in the mat. The mat was kept moist to allow the seeds to germinate and grow. The seeds sprouted and the small sprouts were visible in about 4 days. When the plants reached about 3 inches about one teaspoon of fertilizer was mixed with one gallon of water and applied to the mat, although the fertilizer can be applied at any time. The remaining fertilizer was applied in the same manner in an additional 4 weeks, although the fertilizer can be applied at any time. The lettuce was then harvested when it reached an optimal size.

### Example 5

A process like that in Example 3 was performed, except the container was placed under artificial lights to promote growth. Similar results were obtained.

### Example 6

A process like that in Example 4 was performed, except the container was placed under artificial lights to promote growth. Similar results were obtained.

### Example 7

The mat was used to grow lettuce in the manners described above using different thicknesses of the mat provided in the kit of the present invention. The thicknesses ranged from 0.50 inches to 3 inches. As previously noted, all thicknesses allowed germination and full growth of the seeds.

### Example 8

The mat was placed on a perforated plastic tray and the tray was placed in a plastic container. For instance, the plastic container is available from Sterilite Corporation. The mat was saturated with water. Lettuce and basil seeds were placed in receptacles formed in the mat. The mat was kept moist to allow the seeds to germinate and grow. The mat was fertilized throughout the growth process. The plants grew and roots penetrated the perforated tray and the tray could be lifted out of the container to expose the root systems.

The methods and processes illustratively described herein may be suitably practiced in differing orders of steps. They are not necessarily restricted to the orders of steps indicated herein or in the claims. The compositions described and claimed herein may comprise, consist of, or consist essentially of any of the recited ingredients in any combination.

As used herein and in the appended claims, the singular forms “a,” “an,” and “the” include plural reference unless the context clearly dictates otherwise.

Under no circumstances may the patent be interpreted to be limited to the specific examples or aspects or methods specifically disclosed herein. Under no circumstances may the patent be interpreted to be limited by any statement made by any Examiner or any other official or employee of the Patent and Trademark Office unless such statement was specifically and without qualification or reservation expressly adopted by Applicant in a responsive writing specifically relating to the application that led to this patent prior to its issuance.

The terms and expressions employed herein have been used as terms of description and not of limitation, and there is no intention in the use of such terms and expressions, or any portions thereof, to exclude any equivalents now know or later developed, whether or not such equivalents are set forth or shown or described herein or whether or not such equivalents are viewed as predictable, but it is recognized that various modifications are within the scope of the invention claimed, whether or not those claims issued with or without alteration or amendment for any reason. Thus, it shall be understood that, although the present invention has been specifically disclosed by preferred embodiments and optional features, modifications and variations of the inventions embodied therein or herein disclosed can be resorted to by those skilled in the art, and such modifications and variations are considered to be within the scope of the inventions disclosed and claimed herein.

Specific methods and compositions described herein are representative of preferred embodiments and are exemplary and not intended as limitations on the scope of the invention. Other objects, aspects, and embodiments will occur to those skilled in the art upon consideration of this specification, and are encompassed within the spirit of the invention as defined by the scope of the claims. Where examples are given, the description shall be construed to include but not to be limited to only those examples. It will be readily apparent to one skilled in the art that varying substitutions and modifications may be made to the invention disclosed herein without departing from the scope and spirit of the invention, and from the description of the inventions, including those illustratively set forth herein, it is manifest that various modifications and equivalents can be used to implement the concepts of the present invention without departing from its scope. A person of ordinary skill in the art will recognize that changes can be made in form and detail without departing from the spirit and the scope of the invention. The described embodiments are to be considered in all respects as illustrative and not restrictive. Thus, for example, additional embodiments are within the scope of the invention and within the following claims.

What is claimed is:

1. A plant germination and growth kit, comprising:
a mat, said mat comprising a growth medium; and
at least one seed.

2. The kit of claim 1, further comprising instructions.

3. The kit of claim 2, wherein said instructions are integral with said mat.

4. The kit of claim 1, further comprising backing provided against a surface of said mat.

5. The kit of claim 1, wherein said mat comprises at least one receptacle formed therein.

6. The kit of claim 1, further comprising a planting container.

7. The kit of claim 6, wherein said mat is pre-cut to fit said planting container.

8. The kit of claim 1, wherein said mat comprises a plurality of mats.

9. The kit of claim 1, wherein said growth medium is bound together with a biodegradable polymer.

10. The kit of claim 1, further comprising a growth stand and a growth light for indoor growth.

11. The kit of claim 1, wherein the at least one seed comprises a plurality of different seeds.

12. The kit of claim 1, wherein said mat has a thickness of between about 0.25 inches and about 3.0 inches.

13. The kit of claim 1, wherein said growth medium is selected from the group consisting of peat moss, coconut coir, combusted bark, fresh bark, composted organic waste, expended volcanic ash, milled corncob, nut shells, seed hulls, sawdust, hemp, silk, cellulose, wool, polyesters, polyacrylonitrile, polyvinyl alcohol, polyolefims, polyamides and cellulose-based materials.

14. The kit of claim 1, further comprising a tray with at least one perforation formed therein and an exterior container for receiving said tray, wherein said tray may be removed from said container during growth.

15. The kit of claim 1, wherein said at least one seed is packaged in a first package.

16. The kit of claim 15, wherein said fertilizer is packaged in a second package.

17. The kit of claim 1, further comprising fertilizer.

18. The kit of claim 17, wherein said fertilizer is integral with said mat.

19. A method for cultivating a garden, comprising:
providing a mat;
providing seeds;
providing fertilizer; and,
placing said mat on a surface;
placing seeds on said mat; and
placing fertilizer on said mat.

20. The method of claim 19, further comprising:
placing said mat on a surface, wherein said surface has not been prepared.
